(19) United States
(12) Patent Application Publication
(10) Pub. No.: US 2019/0185719 A1
(43) Pub. Date: Jun. 20, 2019

(54) METHOD FOR BOOSTING THE ANCHORAGE IN THE COATING OF A CARRIER WITH A SOLVENT-FREE ADHESIVE COMPOSITION BY SUPERFICIAL CARRIER HEATING BY MEANS OF CONTACT-AREA HEAT TRANSFER

(71) Applicant: tesa SE, Norderstedt (DE)

(72) Inventors: Thomas SCHABERNACK, Ettenheimmünster (DE); Oliver BECHT, Kirchzarten (DE); Markus ZAGERMANN, Haslach (DE); Gerhard VOGT, Oberkirch (DE); Christof-Gottfried HOELGER, Weil am Rhein (DE)

(73) Assignee: tesa SE, Norderstedt (DE)

(21) Appl. No.: 16/222,252

(22) Filed: Dec. 17, 2018

(30) Foreign Application Priority Data
Dec. 18, 2017 (DE) 10 2017 223 003.7

(51) Int. Cl. C09J 7/21; C09J 7/35; B65H 51/04

(52) U.S. Cl. CPC C09J 7/21; C09J 7/35; B65H 2401/141; C09J 2205/10; B65H 2401/13; B65H 51/04

(57) ABSTRACT

A method for producing an adhesive tape by coating a carrier material in web form with a solvent-free adhesive composition, wherein immediately prior to the coating of the carrier material with the adhesive composition, the surface of the adhesive composition or the surface of the carrier material or the surface both of the adhesive composition and of the carrier material is heated by introduction of heat to a temperature of at least 30° C. above the processing temperature, has the effect that the adhesive composition is significantly better anchored on the carrier. For an adhesive tape produced in this way, a boost in the anchorage by up to 60% can be achieved. The penetration of the composition into carriers, especially rough carriers, can take place very much more easily under the conditions of the high temperatures and is controllable by means of the temperature regime.

This application claims priority of German Patent Application No. 10 2017 223 003.7, filed Dec. 18, 2017, the disclosure of which is incorporated herein by reference in its entirety.

The present invention relates to a method for producing an adhesive tape by coating a carrier material in web form with a solvent-free adhesive composition.

The coating of carrier materials, especially rough carrier materials such as woven fabrics, nonwovens or paper carriers, with such solvent-free adhesive compositions, also called hotmelts, by means of corresponding application methods via dies or using calendering technology is known. In such operations, especially when using adhesive compositions of high viscosity, there may be problems with anchoring and transfer of the adhesive composition on and onto the carrier material, respectively. The consequence thereof are disadvantages from the standpoints of performance and method, examples of such disadvantages being residues of adhesive composition and/or lack of transfer to the carrier. It follows from this that the material can be further processed only with considerable difficulties and/or fails to meet the customer requirements. For the abovementioned coating methods, the temperatures of the composition and of the carrier are important processing variables, which likewise affect the product properties. The temperature of the composition is determined essentially by the temperature of the composition line, which cannot be increased ad infinitum since otherwise the composition will suffer damage. Similar comments apply in respect of the carrier, which may indeed be preheated in processing. The carrier temperatures selected, however, must likewise be low enough not to damage the carrier. A temperature increase of this kind applied to the entire composition is employed in US2011/0183100, for example. US2017/0298255 as well aims to improve anchoring by heating carrier and adhesive composition. Here again, however, in view of the nature of the supply of heat, by means of infra-red heat source or through an internal heat source, the temperature is increased not only on the surface.

In order to achieve a depth of penetration of the carrier by the adhesive composition that is sufficient for good transfer of adhesive composition and anchoring, it is therefore known practice to press the adhesive composition subsequently into the carrier. Such processing, however, is susceptible to faults and requires additional and specific equipment.

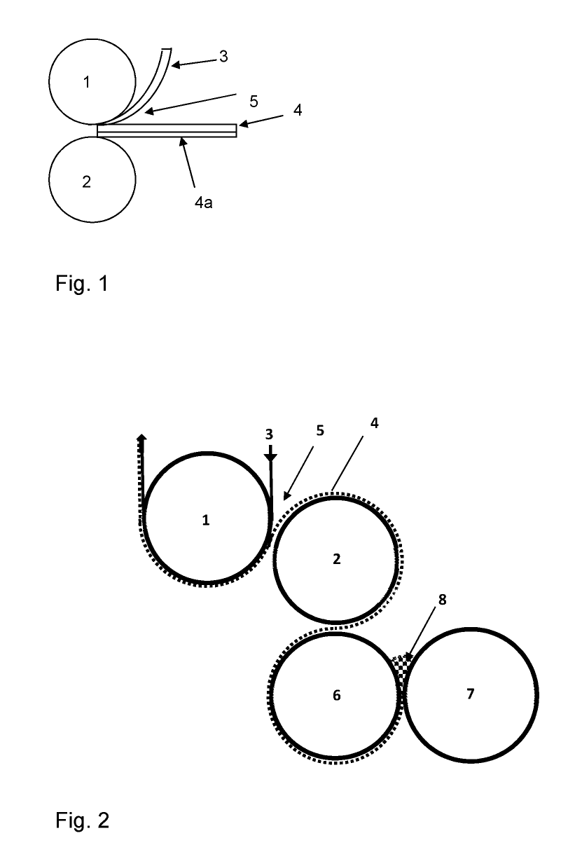

FIG. 1 is a schematic of a laboratory calender.

FIG. 2 is a schematic of a calender on the technical scale.

It was an object of the present invention, therefore, to provide a method with which the transfer of a hotmelt onto surfaces, especially rough surfaces, and the anchoring on the surface are improved. At the same time, there should as far as possible be no additional operation.

In accordance with the invention, in a method of the type specified at the outset, this object is achieved in that immediately before the coating of the carrier material with the adhesive composition, the surface of the adhesive composition or the surface of the carrier material or the surface both of the adhesive composition and of the carrier material is heated by introduction of heat to a temperature of at least 30° C. above the processing temperature.

The effect of this superficial heating of the composition and/or of the carrier well above the customary processing temperatures before the first contact of the composition with the carrier in the applicator unit is that the adhesive composition is anchored significantly more effectively on the carrier. A boost in the anchorage by up to 60% can be achieved. Penetration of the rough carrier by the composition can be accomplished very much more easily under the conditions of the high temperatures, and is controllable by means of the temperature regime.

Heating, however, in fact takes place only at the surface and only for a short time. The cooling and the necessary rapid lowering of the temperatures below the critical levels take place very quickly and effectively as a result of the propagation of the heat into the interior of the carrier and of the composition, and so there is no damage to the material, even at the surface, and the effective increase of the temperatures in the processing line is moderate.

The heating of the surface takes place to a temperature of at least 30° C. above the processing temperature. Preferably there is an increase of at least 50° C., more preferably of at least 70° C. and more particularly of at least 100° C. above the processing temperature. It is preferred, moreover, if the increase in the temperature of the surface of the adhesive composition or of the surface of the carrier material, or of the surface both of the adhesive composition and of the carrier material, by introduction of heat, is not more than 200° C., preferably at most 150° C., more particularly at most 120° C. above the processing temperature, since in this way any damage to the carrier and/or adhesive composition can be avoided.

The method of the invention allows products to be produced which cannot, or cannot easily, be produced with conventional hotmelt technology. In particular, coating may even take place with sensitive materials, such as heat-activatable or heat-sensitive adhesive compositions.

The coating takes place preferably via extrusion dies or, in particular, via a calender unit. Coating by means of roll coating applicator units or multi-roll coating calenders, consisting of preferably three, more preferably of four, coating rolls, with the self-adhesive composition being shaped to the desired thickness as it passes through one or more roll nips before transferring to the material in web form is preferred especially when the viscosities of the self-adhesive composition exceed levels of 5000 Pa·s at a shear rate of 1 rad/s.

In the process of coating by the calender method, furthermore, the temperature regime may favourably influence the transfer of composition from the calender roll to the carrier and thereby expand the processing window, not least in the direction of lower temperatures, hence enabling a reduction in start-up losses as well, in particular.

In one particularly preferred embodiment of the present invention, the heating takes place by means of thermal conduction or convection (hot air), preferably by techniques of contact-area heat transfer by means of heating rolls, heating elements, or by a combination of the aforementioned techniques. Heating by means of hot air in particular, for example, is easily possible without any need to employ special equipment.

Particularly good results are achievable if the introduction of the heat takes place less than 100 ms, preferably less than 70 ms, more particularly less than 50 ms before the coating of the carrier material with the adhesive composition, and hence a very short time before contact in the applicator unit. In this way, the fact of the surface not being sufficiently hot, in other words having already cooled down again before the adhesive composition is anchored on the carrier material, as a result of the rapid dissipation of heat into the interior of the material, is prevented.

The processing temperature for the coating is especially suitably in the range from 10° C. to 160° C., preferably in the range from 20° C. to 150° C., more preferably in the range from 35° C. to 120° C., more particularly in the range from 50° C. to 100° C. On roll coating applicator units or multi-roll coating calenders, coating at temperatures below 100° C. is possible, so permitting coating even with self-adhesive compositions which include thermally activatable crosslinkers. The processing temperature here is understood as that temperature which the carrier material would have without additional application of heat according to the method described.

The surface temperature of the coating calender here is preferably less than 180° C., more particularly from 170° C. to 110° C.

To make the coated adhesive composition contain fewer gas bubbles, a vacuum devolatilizing facility, for example a vacuum chamber or a devolatilizing extruder, may be provided ahead of the applicator unit.

Suitable carrier materials, depending on the intended use of the adhesive tape, are all known carriers, where appropriate with corresponding chemical or physical surface pretreatment of the coating side and anti-adhesive physical treatment of the reverse side.

Suitability is possessed here in particular by woven fabrics, knitted fabrics, nonwovens, foams and paper, creped or uncreped, the woven fabrics, knitted fabrics and nonwovens consisting of one or more natural fibres, of one or more synthetic fibres or of a mixture of natural and synthetic fibres. Foams may consist, for example, of polyethylene or polyurethane.

The present invention finds application in the processing of hotmelt adhesive compositions, more particularly those based on non-thermoplastic elastomers.

The non-thermoplastic elastomer is advantageously selected from the group of natural rubbers or synthetic rubbers or consists of any desired blend of natural rubbers and/or synthetic rubbers, the natural rubber or natural rubbers being selectable in principle from all available grades such as, for example, crepe, RSS, ADS, TSR or CV products, according to the requisite levels of purity and of viscosity, and the synthetic rubber or synthetic rubbers being selectable from the group of randomly copolymerized styrene-butadiene rubbers (SBR), butadiene rubbers (BR), synthetic polyisoprenes (IR), butyl rubbers (IIR), halogenated butyl rubbers (XIIR), acrylate rubbers (ACM), ethylene-vinyl acetate copolymers (EVA) and polyurethanes and/or blends thereof.

Preferably, moreover, in order to improve the processing qualities, the non-thermoplastic elastomers may be admixed with thermoplastic elastomers in a weight fraction of 10 to 50 wt %, this figure being based on the total elastomer fraction. Representatives at this point will include in particular the especially compatible styrene-isoprene-styrene (SIS) and styrene-butadiene-styrene (SBS) products.

Tackifying resins which can be used are, without exception, all tackifier resins already known and described in the literature. Representatives will include the rosins, their disproportionated, hydrogenated, polymerized and esterified derivatives and salts, the aliphatic and aromatic hydrocarbon resins, terpene resins and terpene-phenolic resins. Any desired combinations of these and further resins may be used in order to bring the properties of the resultant adhesive composition into line with requirements. Reference may be made expressly to the depiction of the state of the art in “Handbook of Pressure Sensitive Adhesive Technology” by Donatas Satas (Van Nostrand, 1989).

Plasticizers which can be used are all of the plasticizing substances known from the technology of adhesive tapes. These include, among others, the paraffinic and naphthenic oils, (functionalized) oligomers such as oligobutadienes and/or isoprenes, liquid nitrile rubbers, liquid terpene resins, vegetable and animal oils and fats, phthalates and functionalized acrylates.

For the purposes of thermally induced chemical crosslinking, with the method of the invention it is possible to use all known, thermally activatable, chemical crosslinkers such as accelerated sulfur systems or sulfur donor systems, isocyanate systems, reactive melamine resins, formaldehyde resins and (optionally halogenated) phenol-formaldehyde resins and/or reactive phenolic resin crosslinking systems or diisocyanate crosslinking systems with the corresponding activators, epoxidized polyester resins and acrylate resins, and also combinations thereof.

The outcome of the method of the invention is also affected by the coating speed. Coating takes place suitably in an operating speed in the range from 5 m/min to 300 m/min, preferably between 10 m/min to 100 m/min and more particularly between 10 m/min to 70 m/min.

The present invention further relates to an adhesive tape obtained by the method of the invention, the carrier material being coated on at least one side with the adhesive composition. With an adhesive tape of the invention, by virtue of the brief increase in temperature shortly prior to coating, it is possible to lower the viscosity of the adhesive composition and to increase drastically the fluidity of the composition. The result of this is a greater depth of penetration of the carrier by the adhesive composition, thereby increasing the anchorage of the adhesive composition on the carrier.

The properties of the adhesive composition such as degree of crosslinking, bond strength and cohesive properties, for example, are not influenced by the brief heating, but instead remain unchanged.

Especially favourably, the thickness of the solvent-free layer of adhesive composition in the case of the adhesive tape of the invention is in the range from 10 μm to 2000 μm, preferably from 15 μm to 1000 μm and more particularly from 20 μm to 500 μm.

### WORKING EXAMPLES

### Test Methods

### Anchorage

The bonding strength of an adhesive composition to the carrier is tested in accordance with test method J0PMC013.

### Holding Power (Static Shear Test SST)

A rectangular test specimen measuring 13 mm×20 mm of the double-sided adhesive tape under test is bonded between two steel plaques (50 mm×25 mm×2 mm; material as per DIN EN 10088-2, type 1, 4301, surface quality 2R, cold-rolled and bright-annealed, Ra=25-75 nm) in such a way that the bond area of the test specimen with both steel plaques is 260 mm² in each case; the steel plaques are oriented in parallel with an offset in the longitudinal direction, and so the test specimen is bonded centrally between them and the steel plaques protrude beyond the test specimen on different sides. The bonded assembly is then pressed for 1 minute with an applied pressure of 100 N/cm². After a specified time for the bond to take (72 hours at room temperature unless otherwise stated), the test elements prepared in this way are suspended, by one steel plaque region protruding beyond the test specimen, on a shear test measurement area, in such a way that the longitudinal direction of the steel plaques points downwards, and the region of the other steel plaque that protrudes beyond the test specimen is loaded, at a specified temperature, with a selected weight (measurements at room temperature and with 20 N load and also at 70° C. and with 10 N load; see details in the respective table). Test conditions: standard conditions, 50% relative humidity. An automatic clock then determines the time elapsing until failure of the test specimens, in minutes (the steel plaque under load drops off).

### Peel Adhesion (PA) to Steel

A strip of the (pressure-sensitive) adhesive tape under investigation is bonded in a defined width (standard: 20 mm) to a ground steel plate (stainless steel 302 according to ASTM A 666; 50 mm×125 mm×1.1 mm; bright annealed surface; surface roughness Ra=50±25 nm average arithmetic deviation from the baseline) by being rolled down ten times with a 5 kg steel roller. Double-sided adhesive tapes are reinforced on the reverse with an unplasticized PVC film 36 μm thick. Identical samples are produced and are alternatively provided for immediate measurement, stored for 3 days and then measured, or stored for 14 days and then measured.

The prepared plate is clamped (fixed) into the testing apparatus, and the adhesive strip is peeled from the plate via its free end in a tensile testing machine at a peel angle of 90° and at a speed of 300 mm/min in the longitudinal direction of the adhesive tape. The force necessary for performing this operation is recorded. The results of measurement are reported in N/cm (force standardized to the particular distance of bond parting) and are averaged over three measurements. All of the measurements are carried out in a conditioned room at 23° C. and 50% relative humidity.

### Static Glass Transition Temperature T_{g}

The static glass transition temperature is determined by differential scanning calorimetry in accordance with DIN 53765. The figures for the glass transition temperature, T_{g}, pertain to the DIN 53765:1994-03 glass transition temperature value T_{g}, unless specifically indicated otherwise.

### EXAMPLES

The adhesive composition used for the experiments was a rubber adhesive composition produced from:
43.0 wt % of natural rubber (type SVR 3 L)
51.0 wt % of Dertophene T 105 and
6.0 wt % of Wingtack 10.

Production took place in a planetary roller extruder having three roller cylinders, with each roller cylinder being equipped with 6 planetary spindles. The rotary speed of the central spindle was set at 100 revolutions/min. A premix was produced from the components, and was metered via a volumetric metering facility into the filling section of the planetary roller extruder. The temperature-control circuits for the central spindle and for the filling section were water-cooled; each roller section was heated at 100° C. The temperature of the emerging composition was 112° C.

### Fundamental Experiment on the Laboratory Scale (Laboratory Calender)

In this experiment, the rubber adhesive composition, coated out onto release paper with a coat weight of 100 g/m², was calendered with a woven cotton fabric. Calendering was carried out using a laboratory calender (2-roll construction). The laboratory calender is shown in FIG. 1. The calender has an HNBR (hydrogenated acrylonitrile-butadiene rubber) roll 1 and also a steel roll 2. In the calender nip, before the first contact of the adhesive composition 4, coated out onto release paper 4a (100 g/m²) with the woven cotton fabric 3, superficial heating of the surface of composition and of fabric is performed by means of hot air. The input of hot air at the calender nip is denoted by 5. Results obtained for the anchorage (J0PMC013) were as follows.

TABLE 1
Results of fundamental experiment

| | | | Difference N/cm |
|---|---|---|---|
| Values (n = 3) [N/cm] | Anchorage [N/cm] | | with/without hot |
| Pressure [N/mm] | Without hot air | With hot air | air |
| 100 | 8.7 | 14.9 | 6.2 |
| 50 | 7.9 | 13.8 | 5.9 |
| 10 | 5.7 | 11.8 | 6.1 |

TABLE 2
Results of reproduction experiment - fundamental experiment

| | | | Difference N/cm |
|---|---|---|---|
| Values (n = 3) [N/cm] | Anchorage [N/cm] | | with/without hot |
| Pressure [N/mm] | Without hot air | With hot air | air |
| 50 | 8.1 | 14.4 | 6.3 |

In order to rule out any change in properties of the rubber adhesive composition, the parameters of holding power, peel adhesion to steel, and static glass transition temperature (T_{g}) were investigated.

TABLE 3
Results of analysis of the properties of the adhesive composition after hot
air treatment

| | | | Difference N/cm |
|---|---|---|---|
| Values (n = 3) [N/cm] | Without | | with/without |
| Test parameter | hot air | With hot air | hot air |
| Holding power [min] | 856 | 1022 | 166 |
| Peel adhesion to steel | 4.63 | 4.3 | −0.33 |
| [N/cm] | | | |
| T_{g} [° C.] at 10 rad/s | −4 | −5 | −1 |

The fundamental experiment shows that by heating of the surfaces of composition and of fabric it is possible to boost the anchorage. For the purpose of the experiments, hot air was used for heating. Other methods of heating are also conceivable. It was shown, moreover, that the rubber adhesive composition is not altered as a result of the brief heating, with relevant parameters of the adhesive composition instead remaining unchanged within the bounds of measurement accuracy.

### Scale-Up: Hot Air Experiments in the Technology Centre

After the positive results on the laboratory scale, the hot air experiments in accordance with the invention were carried out with heating of rubber adhesive composition and fabric surface on the technical scale. The coating line is shown diagrammatically in FIG. 2.

Between a first roll 7 and a second roll 6, the adhesive composition 8 from the extruder is rolled into a layer. Via the calender roll 2, on which the adhesive composition 4 which has been rolled into a layer is located, this composition is used to coat the woven cotton fabric 3 which runs on the opposing polymer roll 1. The hot air input at the calender nip is denoted by 5. For the scale-up experiments, an NRE adhesive composition was used.

Table 4 reproduces the results of measurement of the anchorage after seven days of storage with/without hot air at different coating speeds, for comparison. Here it is found that the effect of heating is greater at lower coating speeds than at higher speeds.

TABLE 4
Comparison of results of adhesive composition properties
with/without hot air treatment

Anchorage [N/cm]

| Values (n = 3) | | | Difference |
|---|---|---|---|
| [N/cm] | Without hot | With hot | with/without |
| Speed [m/min] | air | air | hot air |
| 15 | 12 | 15.1 | 2.9 |
| 20 | 11.4 | 13 | 1.6 |
| 100 | 9.9 | 11 | 1.1 |

The experiment in the technology centre showed that the principle of the superficial heating of composition and of fabric can be employed for boosting the anchorage even on the larger scale. Furthermore, with a constant input of energy by means of hot air, for example, it was possible to demonstrate an effect of speed.

1. Method for producing an adhesive tape by coating a carrier material in web form with a solvent-free adhesive composition, wherein immediately before the coating of the carrier material with the adhesive composition, the surface of the adhesive composition or the surface of the carrier material or the surface both of the adhesive composition and of the carrier material is heated by introduction of heat to a temperature of at least 30° C. above the processing temperature.

2. Method according to claim 1, wherein the heating takes place by means of thermal conduction or convection.

3. Method according to claim 1, wherein the heating takes place by contact-area heat transfer.

4. Method according to claim 1, wherein the heating takes place by heating rolls.

5. Method according to claim 1, wherein the heating takes place by heating elements.

6. Method according to claim 1, wherein the heating takes place by a combination of contact-area heat transfer, heating rolls, and heating elements.

7. Method according to claim 1, wherein the coating takes place via extrusion dies or via a calender unit.

8. Method according to claim 1, wherein the heat is introduced less than 100 ms before the coating of the carrier material with the adhesive composition.

9. Method according to claim 1, wherein the heat is introduced less than 70 ms before the coating of the carrier material with the adhesive composition.

10. Method according to claim 1, wherein the heat is introduced less than 50 ms before the coating of the carrier material with the adhesive composition.

11. Method according to claim 1, wherein the processing temperature is in the range from 10° C. to 160° C.

12. Method according to claim 1, wherein the processing temperature is in the range from 20° C. to 150° C.

13. Method according to claim 1, wherein the processing temperature is in the range from 35° C. to 120° C.

14. Method according to claim 1, wherein the processing temperature is in the range from 50° C. to 100° C.

15. Method according to claim 1, wherein the surface of the adhesive composition or the surface of the carrier material or the surface both of the adhesive composition and of the carrier material is heated by introduction of heat to a temperature of at least 50° C. above the processing temperature.

16. Method according to claim 1, wherein the surface of the adhesive composition or the surface of the carrier material or the surface both of the adhesive composition and of the carrier material is heated by introduction of heat to a temperature of at least 70° C. above the processing temperature.

17. Method according to claim 1, wherein the surface of the adhesive composition or the surface of the carrier material or the surface both of the adhesive composition and of the carrier material is heated by introduction of heat to a temperature of at least 100° C. above the processing temperature.

18. Method according to claim 1, wherein the surface of the adhesive composition or the surface of the carrier material or the surface both of the adhesive composition and of the carrier material is heated by introduction of heat to a temperature of at most 200° C. above the processing temperature.

19. Method according to claim 1, wherein the surface of the adhesive composition or the surface of the carrier material or the surface both of the adhesive composition and of the carrier material is heated by introduction of heat to a temperature of at most 150° C. above the processing temperature.

20. Method according to claim 1, wherein the surface of the adhesive composition or the surface of the carrier material or the surface both of the adhesive composition and of the carrier material is heated by introduction of heat to a temperature of at most 120° C. above the processing temperature.

21. Method according to claim 1, wherein the carrier material is a material selected from the group consisting of woven fabrics, knitted fabrics, nonwovens, foams and paper, the woven fabrics, knitted fabrics and nonwovens consisting of one or more natural fibres, of one or more synthetic fibres or of a mixture of natural and synthetic fibres.

22. Method according to claim 1, wherein the coating takes place in an operating speed in the range from 5 m/min to 300 m/min.

23. Method according to claim 1, wherein the coating takes place in an operating speed in the range from 10 m/min to 100 m/min.

24. Method according to claim 1, wherein the coating takes place in an operating speed in the range from 10 m/min to 70 m/min.

25. Adhesive tape obtained by the method according to claim 1, wherein the carrier material is coated on at least one side with the adhesive composition.

26. Adhesive tape according to claim 10, wherein the thickness of the solvent-free layer of adhesive composition is in the range from 10 μm to 2000 μm.

27. Adhesive tape according to claim 10, wherein the thickness of the solvent-free layer of adhesive composition is in the range from 15 μm to 1000 μm.

28. Adhesive tape according to claim 10, wherein the thickness of the solvent-free layer of adhesive composition is in the range from 20 μm to 500 μm.
